(19) United States
(12) Patent Application Publication
(10) Pub. No.: US 2016/0080223 A1
(43) Pub. Date: Mar. 17, 2016

(54) DYNAMIC MANAGEMENT OF NOTIFICATIONS

(71) Applicant: Electro-motive Diesel Inc., LaGrange, IL (US)

(72) Inventors: Alexander Shubs, JR., Chicago, IL (US); David M. Roenspies, Elburn, IL (US)

(73) Assignee: Electro-motive Diesel Inc., LaGrange, IL (US)

(21) Appl. No.: 14/955,042

(22) Filed: Dec. 1, 2015

(51) Int. Cl. H04L 12/26; H04L 29/08

(52) U.S. Cl. CPC H04L 43/04; H04L 67/12; H04L 67/26

(57) ABSTRACT

A method of managing notifications relating to at least one train asset is provided. The method includes receiving an information from the train asset and further analyzing the information received. The first set of notifications is generated based on the analysis of the information received. A second set of notifications is prepared from the first set of notifications by removing at least one notification based on a first predetermined set of rules, silencing at least one notification based on a second predetermined set of rules, cancelling at least one notification based on a third predetermined set of rules, and prioritizing at least one notification based on a fourth predetermined set of rules. Thereafter, the second set of notifications is displayed to the user. A number of notifications in the second set of notifications is less than a number of notifications in the first set of notifications.

### TECHNICAL FIELD

The present disclosure relates to management of notifications, and more specifically, to a method for managing notifications relating to a train asset.

### BACKGROUND

Trains have multiple sub-systems and components including an engine, a fuel supply, doors, lights, an intercom, converters, a braking, a traction, an air conditioning, a power supply, a signaling sub-system, and an exhaust sub-system to name a few. Each sub-system and component requires continuous monitoring, in order to timely diagnose faults and perform repairs or maintenance activity for the train asset. A failure to timely monitor sub-systems and components of the train asset may result in a failure to identify faults at the right time, which in turn results in an unnecessary downtime of the train asset. In other cases, failure to timely monitor sub-systems and components of the train asset may result in an operational mishap causing large scale loss of human life and money. Thus, timely monitoring and maintenance of train asset is important to avoid unnecessary downtime and operational mishap.

Currently, various systems are available to timely monitor sub-systems and components of train assets. Typically, these systems employ sensors in a train asset to monitor real-time operational data. These sensors generate operational data of each sub-system and component of the train asset. Thereafter, the sensor data is provided to users in form of notifications. At times, a large number of notifications may be sent to a particular user, due to a large number of sub-systems and components being monitored in the train asset. Some notifications may include status information of a component, and other notifications may include fault information, which is likely to result in a failure of the component of the train asset. A large number of notifications sent to the user may become unmanageable for the user, and may result in the user missing critical notifications including fault information. Moreover, some notifications may not be relevant or actionable for the user and may cause unnecessary inconvenience to the user. Thus, there exists a need to manage notifications more effectively and prevent any chance of missing a relevant notification by the user.

Publication Number WO2004/024531 relates to a diagnostic apparatus for monitoring a vehicle. The diagnostic apparatus includes a plurality of sensors for generating measured data relating to the operation of the monitored components, one or more sensors for generating environmental data relating to the current operating environment of the monitored components, data processing means for receiving the measured data and environmental data and correlating at least a portion of the data to generate condition data relating to the condition of the system, and data transmission means for transferring at least a portion of the condition data to an external data processing system. However, such a system also provides a large number of notifications to users, which may result in the users missing critical notifications. Therefore, there exists a need to manage notifications more effectively and prevent any chance of missing a relevant notification by the user.

### SUMMARY OF THE DISCLOSURE

In one aspect of the present disclosure, a method for managing notifications relating to at least one train asset is provided. The method includes receiving an information relating to the train asset from the at least one train asset, analyzing the information received from the at least one train asset, and then generating a first set of notifications based on the analysis of the information. The method further includes preparing a second set of notifications using the first set of notifications. The preparation includes removing at least one notification from the first set of notifications using a first predetermined set of rules and then silencing at least one notification in the first set of notifications using a second predetermined set of rules. The preparation further includes cancelling at least one notification in the first set of notifications using a third predetermined set of rules, and prioritizing at least one notification in the first set of notifications using a fourth predetermined set of rules. Thereafter, displaying the second set of notifications to the user. A number of notifications in the second set of notifications is less than a number of notifications in the first set of notifications.

Other features and aspects of this disclosure will be apparent from the following description and the accompanying drawings.

### BRIEF DESCRIPTION OF THE DRAWINGS

FIG. 1 is a block diagram of a system for managing train asset notifications, in accordance with the concepts of the present disclosure;

FIG. 2 is a block diagram of a server for managing the train asset notifications, in accordance with the concepts of the present disclosure; and

FIG. 3 is a flowchart of a method for managing the train asset notifications, in accordance with the concepts of the present disclosure.

### DETAILED DESCRIPTION

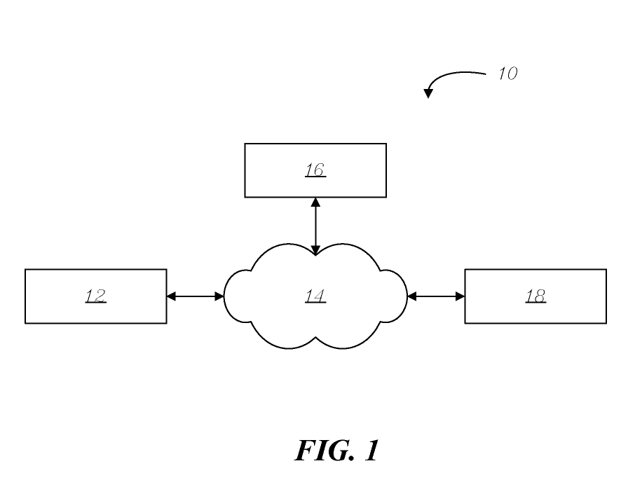

Referring to FIG. 1, the train asset management system 10 includes a train asset 12, a network 14, a server 16, and a user 18. The train asset 12, the server 16 and the user 18 are coupled with the network 14, and are able to communicate with each other over the network 14. For example, an information related to the train asset 12 is communicated to the server 16, and from the server 16 to the user 18 over the network 14, and vice versa.

The train asset 12 includes a plurality of sub-systems and components, for example, but not limited to, an engine, a fuel supply, doors, lights, an intercom, converters, a braking, a traction, a power supply, a signaling sub-system, a Heating Ventilation and Air Conditioning (HVAC) system and an exhaust sub-system. For the purpose of simplicity, the plurality of sub-systems and the components are not shown in FIG. 1. The train asset 12 also includes a plurality of sensors (not shown) that monitor status of the train asset 12, for example, but not limited to, a sensor for monitoring a condition of a braking system of the train asset 12, a sensor for monitoring an operational status of the HVAC system of the train asset 12, and a sensor for monitoring a location of the train asset 12. Based on the monitoring of systems, sub-systems and components, the plurality of sensors generate an information relating the train asset 12 and send the information to the server 16.

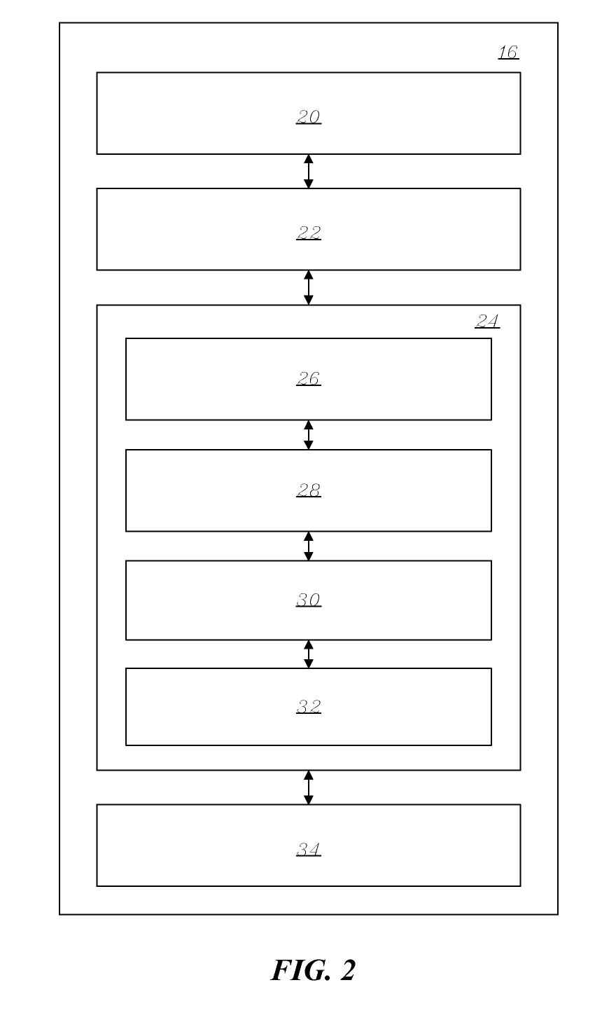

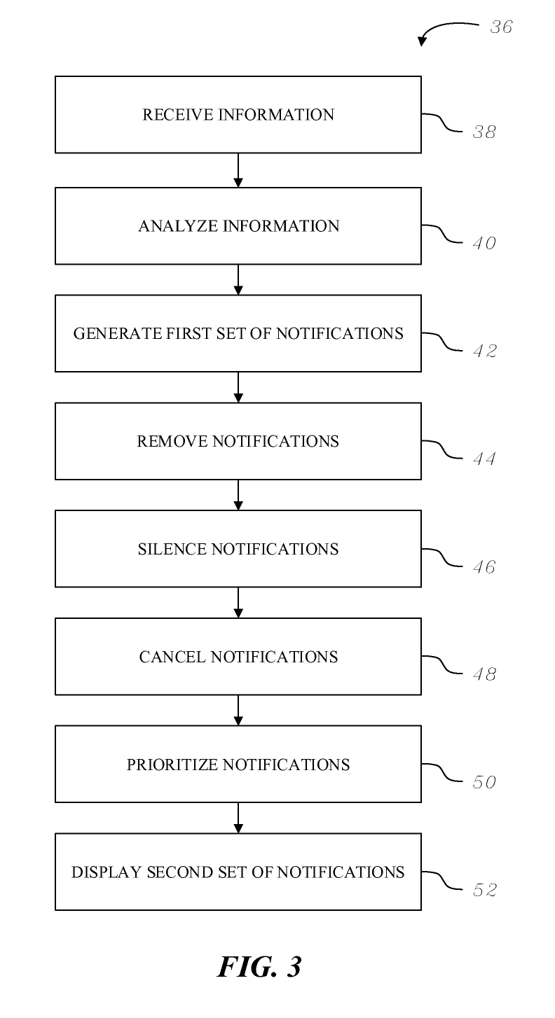

The server 16 receives the information relating to the train asset 12 and analyzes the information received, and generates a first set of notifications. The server 16 further prepares a second set of notifications using the first set of notifications (explained in detail along with FIG. 2 and FIG. 3). The first set of notifications include, but is not limited to, a notification relating to the current location of the train asset 12, a notification related to the temperature of the wheels, a notification related to a fault condition in the braking system, and a notification relating to a scheduled maintenance of the train asset 12.

The server 16 thereafter displays the second set of notifications to the user 18. The second set of notifications are displayed to the user 18 on a device such as, but not limited to, a desktop computer, a laptop computer, a pager, a mobile device, a smartphone, and a personal digital assistant. The user 18 is provided with a virtual representation of the train asset 12 and the second set of notifications are provided as textual labels, numeric values, shading and color coding relative to the virtual representation of the train asset 12. Alternatively, the user 18 may receive the second set of notifications in the form of text messages, for example, but not limited to, a Short Message Service (SMS) or a Multimedia Message Service (MMS), email, phone call, and voicemail. As an example, the user 18 may be a train operator, maintenance personnel, a system engineer and a driver. Although, FIG. 1 shows a single user 18, the train asset management system 10 is able to send the notifications to multiple users without departing from the scope of the present disclosure.

It will be apparent to one skilled in the art that the sever 16 is a standalone server or a cloud server. In alternate embodiments, the server 16 may be present on-board the train asset 12. Further, the network 14 includes, but is not limited to, a Wi-Fi network, a Zigbee network, a cellular communication network, a satellite communication network and a Microwave Access (WiMAX) network.

As shown in FIG. 2, the server 16 includes a receiving module 20, an analyzing module 22, a preparing module 24, and a displaying module 34. The receiving module 20 receives the information relating to the train asset 12, from the train asset 12. The analyzing module 22 analyzes the received information and generates the first set of notifications. Thereafter, the preparing module 24 generates a second set of notifications using the first set of notifications.

The preparing module 24 includes a removing module 26, a silencing module 28, a cancelling module 30, and a prioritizing module 32, which enable the preparing module 24 to generate the second set of notifications. The removing module 26 removes at least one notification from the first set of notifications, using a first predetermined set of rules. The first predetermined set of rules include, but is not limited to, a rule for removing obsolete notifications or out-of-date notifications, a rule for removing a notification relating to a fault condition that does not exist anymore, a rule for removing a notification relating to scheduled maintenance in response to a manually entered status of the maintenance operation of the train asset 12 (for example, when the maintenance work is complete), a rule for removing the notifications based on a profile of the user 18 (for example, the notifications that are not relevant for the user 18), a rule for removing the notifications based on an access history of the notifications by the user 18 (for example, notification that are not accessed by the user 18 on frequent basis).

The silencing module 28 silences at least one notification in the first set of notifications using a second predetermined set of rules, the second predetermined set of rules include, but is not limited to, a rule for silencing a notification based on priority (for example, a notification relating to a monthly maintenance status is suppressed over the weekly maintenance status of the train asset 12 for a maintenance personal), a rule for silencing a notification based on time of the day (for example, a notification relating to the fault in braking system generated in the morning is silenced for a user, who works in the evening), and a rule for making a notification temporarily invisible based on a profile of the user 18 (for example, a notification relating to an HVAC system of the train asset 12 is cancelled for a driver while he is driving). The silencing module 28 does not remove the notifications, and the notifications are sent to the user 18, however, the notifications may be moved to a separate area in a graphical user interface (GUI) of a device carried by the user 18, but may still be accessed by the user 18.

The cancelling module 30 cancels at least one notification in the first set of notifications using a third predetermined set of rules, the third predetermined set of rules may include, but is not limited to, a rule for cancelling a notification based on a profile of the user 18 (for example, a notification relating to a maintenance status of the train asset 12 is cancelled for a maintenance personal while the train asset 12 is away from the maintenance bay), a rule for cancelling a notification based on an operational status of the train asset 12 (for example, a notification relating to a location of the train asset 12 is cancelled for a driver of the train asset 12).

Further, the prioritizing module 32 prioritizes at least one notification in the first set of notifications using a fourth predetermined set of rules, the fourth predetermined set of rules include, but is not limited to, a rule defined by certain users or user types (for example, the user 18 specifies a rule such that a notification relating to the train asset 12 is provided on the top, and a notification related to monthly maintenance of the train asset 12 is provided at the bottom in the GUI), a rule for prioritizing notifications based on nature of a notification (for example, a notification relating to a fault in an engine is prioritized over a notification relating to a fault in an HVAC system), a rule for prioritizing notifications based on a profile of the user 18 (for example, a notification relating to a maintenance status of the train asset 12 is prioritized over other notifications for a maintenance personal).

The second set of notifications prepared by the preparing module 24 includes a number of notifications which is less than a number of notifications in the first set of notifications. Thereafter, the second set of notifications is displayed to the user 18 by the displaying module 34.

It will be apparent to one skilled in the art that only one of the removing module 26, the silencing module 28, the cancelling module 30, and the prioritizing module 32 may be used for preparing the second set of notifications. Alternatively, more than one of the removing module 26, the silencing module 28, the cancelling module 30, and the prioritizing module 32 are used for preparing the second set of notifications.

Referring to FIG. 3, a method 36 for managing the train asset notifications is shown. At step 38, the information related to the train asset 12 is received by the receiving module 20, from the train asset 12, and then at step 40, the information received is analyzed by the analyzing module 22. At step 42, the first set of notifications is generated using the information analyzed by the analyzing module 22. At step 44, at least one notification in the first set of notifications is removed by the removing module 26, using the first predetermined set of rules. At step 46, at least one notification in the first set of notifications is silenced by the silencing module 28, using the second predetermined set of rules, and then at step 48, at least one notification in the first set of notifications is cancelled by the cancelling module 30, using the third predetermined set of rules. At step 50, at least one notification in the first set of notifications is prioritized by the prioritizing module 32, using the fourth predetermined set of rules. After prioritizing step 50, the second set of notifications is generated, that is displayed by the displaying module 34 to the user 18 at step 52. The number of notifications in the second set of notifications is less than the number of notifications in the first set of notifications.

### INDUSTRIAL APPLICABILITY

Typically, trains are provided with onboard sensors to monitor real-time operational data of the train. The sensors generate operational data of each subsystem and component of the train and provide the operational data to users in form of notifications. At times, a large number of notifications may be sent to a user, which may be irrelevant for the user and cause unnecessary inconvenience. Further, a large number of notifications sent to the user become unmanageable for the user, and result in the user missing critical notifications.

The present disclosure provides a method 36 for managing train asset notifications, wherein the removing module 26 removes obsolete or out-of-date notifications irrelevant to the user 18. The silencing module 28 silences the notifications such that lesser relevant notifications become temporarily invisible or silent to the user 18. The cancelling module 30 cancels the notifications such that the notifications are no longer available to the user 18. Thus, the cancelling module 30 limits the delivery of the notifications to the user 18. The prioritizing module 32 allows sorting of notifications provided to the user 18 such that the notifications most important to the user 18 appear at the top of a notifications list. Thus the method 36 prevents delivery of irrelevant notifications to the user 18, thereby, minimizing the inconvenience to the user 18. As lesser number of notifications are provided to the user 18, and the notifications are provided in a prioritized manner for the user 18, there is minimal chance of missing relevant or critical notifications.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for managing notifications relating to at least one train asset, the method comprising:
receiving an information from the at least one train asset, the information relating to the at least one train asset;
analyzing the information received from the at least one train asset;
generating a first set of notifications, based on the analysis of the information relating to the at least one train asset;
preparing a second set of notifications using the first set of notifications, wherein the preparing includes:
removing at least one notification from the first set of notifications using a first predetermined set of rules,
silencing at least one notification in the first set of notifications using a second predetermined set of rules,
silencing at least one notification in the first set of notifications using a second predetermined set of rules,
cancelling at least one notification in the first set of notifications using a third predetermined set of rules, and
prioritizing at least one notification in the first set of notifications using a fourth predetermined set of rules; and
displaying the second set of notifications to a user, wherein a number of notifications in the second set of notifications is less than a number of notifications in the first set of notifications.
